(19) United States
(12) Patent Application Publication
(10) Pub. No.: US 2026/0078802 A1
(43) Pub. Date: Mar. 19, 2026

(54) SHELL TYPE NEEDLE ROLLER BEARING

(71) Applicant: NTN CORPORATION, Osaka (JP)

(72) Inventor: Yuki OGAWA, Shizuoka (JP)

(73) Assignee: NTN CORPORATION, Osaka (JP)

(21) Appl. No.: 19/106,376

(22) PCT Filed: Aug. 28, 2023
(86) PCT No.: PCT/JP2023/030885

§ 371 Date: Feb. 25, 2025

(30) Foreign Application Priority Data
Sep. 1, 2022 (JP) 2022-139272
Sep. 12, 2022 (JP) 2022-144416

(51) Int. Cl. F16C 33/34; F16C 19/26

(52) U.S. Cl. CPC F16C 33/34; F16C 19/26

(57) ABSTRACT

A shell-type needle roller bearing is provided which includes an outer ring in which a material excellent in corrosion resistance is used, and which can be easily press-fitted and can be manufactured at a low cost. A shell-type needle roller bearing is manufactured that includes a shell-type outer ring made of an austenitic stainless steel material, and having a radially outer surface including a non-heat-treated surface.

### TECHNICAL FIELD

The present invention mainly relates to a shell-type needle roller bearing for an automobile.

### BACKGROUND ART

Automobiles are equipped with an electronically-controlled throttle body (ETB) that adjusts the amount of intake air to an engine. The ETB is provided with a throttle valve for opening and closing a flow path, and an outer ring made of iron such as a case-hardened steel is used in a bearing for supporting rotation of the throttle valve.

For example, the below-identified Patent Document 1 discloses a shell-type needle roller bearing used for such a purpose. This shell type needle roller bearing is manufactured as follows: First, a steel strip made of chromium molybdenum steel (SCM415 or the like) that is the material of the outer ring is prepared. This steel strip is formed into the shape of the outer ring by deep drawing. At this time, only one edge of the outer ring is bent. A cage and needle rollers are placed into the outer ring. After placing them into the outer ring, the other edge of the outer ring is bent to prevent the cage and the needle rollers from moving out of the bearing. After assembling the bearing as described above, a carbonitriding treatment is performed, and then a heat treatment step is performed in which quenching and tempering are performed. Due to the heat treatment, the chromium-molybdenum steel becomes a case-hardened steel in which the surface of the chromium molybdenum steel has been hardened. If the edges of the outer ring are bent after a heat treatment, the hardness of the end portions is changed and is not uniform. However, by performing a heat treatment after assembling the bearing, the hardness of the entire outer ring including both end portions thereof can be made uniform. Also, a nitrogen-enriched layer is formed on a surface layer portion of the outer ring by the carbonitriding treatment. A large amount of retained austenite is present in the nitrogen-enriched layer, and this is plastically deformed to alleviate stress concentration, thereby increasing/extending the life.

### PRIOR ART DOCUMENT

### Patent Document

Patent Document 1: Japanese U.S. Pat. No. 3,212,880

### SUMMARY OF THE INVENTION

### Problems To Be Solved By The Invention

In recent years, an exhaust gas recirculation device (EGR) has been used for a gasoline engine for the purpose of reducing fuel consumption. Due to this, a bearing for a throttle valve of an ETB is exposed to exhaust gas-containing components circulated by the EGR. An outer ring as used in the shell-type needle roller bearing of Patent Document 1, which is formed of a case-hardened steel obtained by treating chromium molybdenum steel, has a problem in that corrosion occurs due to the exhaust gas-containing components. If a shell-type needle roller bearing is used in an environment where corrosion easily occurs, a material having more excellent corrosion resistance needs to be used for the outer ring. Examples of such a material having excellent corrosion resistance include, e.g., an austenitic stainless steel material.

On the other hand, by being press-fitted into a housing having accurate dimensions, the outer ring for the shell-type needle roller bearing achieves accuracy with which its inherent function can be performed. When thus press-fitting the outer ring, since an excessive press-fitting load is applied to the outer ring, the outer ring could deform. Therefore, it is necessary to optimize the surface roughness of the outer ring on the radially outer side thereof in the shell-type needle roller bearing so as to reduce the press-fitting load, thereby preventing deformation thereof. If the roughness is large, when press-fitting the outer ring, the outer ring is caught, and seizure and/or adhesion is likely to occur. For press-fitting, the smaller the roughness, the better, but if the surface of the outer ring is too smooth, seizure is likely to occur between the plate whose surface is smooth and the dice during formation of the outer ring, thus making its manufacture difficult. Especially if an austenitic stainless steel material is used, seizure is likely to occur, and it is difficult to form an outer ring from a steel strip whose surface is smoothened from the beginning. It is possible to first form an outer ring using a steel strip having a non-smooth surface, and then to adjust the smoothness to a target smoothness by a surface treatment such as shot peening, but the cost is too high.

In view of the above-described background, it is a first object of the present invention to provide a shell-type needle roller bearing including an outer ring in which a material excellent in corrosion resistance is used, and which can be easily press-fitted and can be manufactured at a low cost.

Also, the austenitic stainless steel material has a work-hardening coefficient higher than that of a conventional material for a bearing made of iron, and has a characteristic of being work-hardened easily. For this reason, when an austenitic stainless steel material is used to manufacture an outer ring for a shell-type needle roller bearing by deep-drawing, the austenitic stainless steel material adheres to the die due to the influence of work hardening, and a problem such as seizure is likely to occur.

In view of the above-described background, it is a second object of the present invention to provide a shell-type needle roller bearing including an outer ring in which a material excellent in corrosion resistance is used, and which is less likely to generate seizure and is easily manufactured.

### MEANS FOR SOLVING THE PROBLEMS

In order to achieve the above first object, the first invention provides a shell-type needle roller bearing comprising a shell-type outer ring made of an austenitic stainless steel material, wherein the shell-type outer ring has a radially outer surface including a non-heat-treated surface.

Conventionally, when manufacturing a shell-type outer ring made of an austenitic stainless steel material, if a material whose surface is smooth and small in surface roughness is used, seizure occurs during formation by deep drawing, and thus the outer ring cannot be manufactured. However, the inventor discovered that an outer ring whose surface is smooth and small in surface roughness can be formed by increasing the number of stages in deep drawing, and the inventor made it possible to manufacture a shell-type needle roller bearing including such an outer ring. In the thus-formed outer ring made of an austenitic stainless steel material, deep drawing needs to be performed in multiple stages, but the effect of the material being hardened was seen in the deep drawing step. Due to this hardening, it is possible to realize/ensure sufficient hardness in the outer ring without performing a heat treatment after the outer ring is formed, and thus it is possible to omit a heat treatment and machining for smoothing the surface after formation. Therefore, the outer ring is characterized in that the radially outer surface includes a non-heat-treated surface, which is not subjected to a heat treatment.

An arrangement can be used in which the radially outer surface of the shell-type outer ring has a roughness set such that an arithmetic average roughness Ra in an axial direction is 0.04 μm or more and 0.13 μm or less, and such that a skewness Rsk of peaks and valleys in the axial direction is −2.4 m or more and −0.1 m or less.

An arrangement can be used in which the shell-type needle roller bearing of the first invention has an outer diameter dimension of φ 12 mm or more and φ 30 mm or less.

The shell-type needle roller bearing of the first invention is usable while being press-fitted in a housing made of aluminum. The shell-type needle roller bearing is usable, e.g., in an automotive electronic throttle body or an exhaust gas recirculation device as a specific device.

In order to achieve the above second object, the second invention provides a shell-type needle roller bearing having a first arrangement in which the shell-type needle roller bearing comprises a shell-type outer ring made of an austenitic stainless steel material, and a radially outer side surface of at least one of axial width surfaces of the shell-type outer ring is rougher than a radially inner side surface of the at least one of the axial width surfaces.

With respect to formation of the outer ring of the shell-type needle roller bearing from a steel strip, when the steel strip is deformed into a tubular shape, the width surface of the outer ring that corresponds to the tube bottom is relatively lightly machined in the entire outer ring, and thus this width surface is a portion where the material in its original state before being processed is likely to remain. In this portion, in order to make the radially outer side surface rougher than the radially inner side surface, the surface of the original material before being processed that is to be the radially outer side surface should be rougher than the surface of the original material that is to be the radially inner side surface. If the surface to be the radially outer side surface is rougher as described above, oil reservoirs are suitably formed in its roughened concave portion during deep-drawing. Due to this, even if an austenitic stainless steel material, which is likely to generate seizure, is used, it is possible to form the outer ring while reducing seizure.

Also, in the shell-type needle roller bearing according to the second invention, in addition to the first arrangement, a second arrangement can be used in which the radially outer side surface of the at least one of the axial width surfaces has an arithmetic average roughness Ra of 0.2 μm or more and 1.5 μm or less.

Also, the shell-type needle roller bearing according to the second invention having the first or second arrangement can be used in an automotive electronic throttle body or an exhaust gas recirculation device (this embodiment is referred to as “third arrangement”).

### EFFECTS OF THE INVENTION

With respect to the shell-type outer ring partially constituting the shell-type needle roller bearing of the first invention, the number of stages in deep drawing during its manufacture increases compared to a conventional manufacturing method. On the other hand, since the austenitic stainless steel material used is hardened during deep-drawing, it is possible to omit a heat treatment after formation. Also, it is possible to make the radially outer surface have a roughness corresponding to the smoothness of the original steel strip before being deep-drawn, without performing a treatment for smoothening the surface after formation. Since it is possible to omit a heat treatment and a surface treatment (such as shot peening) for adjustment to a target smoothness after the outer ring is formed, it is possible to manufacture a shell-type needle roller bearing excellent in corrosion resistance at a low cost that is not much different from the cost for the outer ring of a conventional product, considering the entire steps. If burrs occur when forming a through-hole in the shell-type outer ring, surface finishing may be performed for the purpose of removing the burrs.

With respect to the outer ring partially constituting the shell-type needle roller bearing of the second invention, by roughening the surface to be located on the radially outer side not after the outer ring is formed by deep-drawing but in the state of a steel strip before being deep-drawn, it is possible to suitably manufacture the outer ring while reducing occurrence of a problem such as seizure in machining. Since it is possible to omit a heat treatment and a surface treatment after the outer ring is formed, it is possible to manufacture a shell-type needle roller bearing excellent in corrosion resistance at a low cost that is not much different from the cost for the outer ring of a conventional product, considering the entire steps.

### BRIEF DESCRIPTION OF THE DRAWINGS

FIG. 1 is a sectional view illustrating one embodiment of a shell-type needle roller bearing according to the first invention.

FIG. 2 is a flowchart illustrating, as one example, the steps of manufacturing the shell-type needle roller bearing according to the first invention.

FIG. 3A is a sectional view of an outer ring deep-drawn that is used in the shell-type needle roller bearing of FIG. 1.

FIG. 3B is an enlarged sectional view illustrating a state in which a through-hole is disposed in a bottom surface in FIG. 3A.

FIG. 3C is an enlarged sectional view illustrating a state in which needle rollers and a cage are disposed in FIG. 3B.

FIG. 3D is an enlarged sectional view illustrating a state in which a flange portion is formed after FIG. 3C.

FIG. 4 is a sectional view illustrating, as an example, a valve of an exhaust gas recirculation device in which the shell-type needle roller bearing according to the first invention is disposed as an example, and the vicinity of the valve.

FIG. 5 is a sectional view illustrating, as an example, a throttle body in which the shell-type needle roller bearing according to the first invention is disposed as one example.

FIG. 6 is a sectional view illustrating one embodiment of a shell-type needle roller bearing according to the second invention.

FIG. 7A is a flowchart illustrating a series of steps of manufacturing a steel strip used for the shell-type needle roller bearing according to the second invention.

FIG. 7B is a flowchart illustrating, as one example, the steps of manufacturing the shell-type needle roller bearing according to the second invention.

FIG. 8A is a sectional view of an outer ring deep-drawn that is used in the shell-type needle roller bearing of FIG. 6.

FIG. 8B is an enlarged sectional view illustrating a state in which a through-hole is disposed in a bottom surface in FIG. 8A.

FIG. 8C is an enlarged sectional view illustrating a state in which needle rollers and a cage are disposed in FIG. 8B.

FIG. 8D is an enlarged sectional view illustrating a state in which a flange portion is formed after FIG. 8C.

FIG. 9 is a sectional view illustrating, as an example, a valve of an exhaust gas recirculation device in which the shell-type needle roller bearing according to the second invention is disposed as one example, and the vicinity of the valve.

FIG. 10 is a sectional view illustrating, as an example, a throttle body in which the shell-type needle roller bearing according to the second invention is disposed as one example.

FIG. 11 is a graph illustrating a press-fitting property evaluation result in an example of the first invention.

### BEST MODE FOR CARRYING OUT THE INVENTION

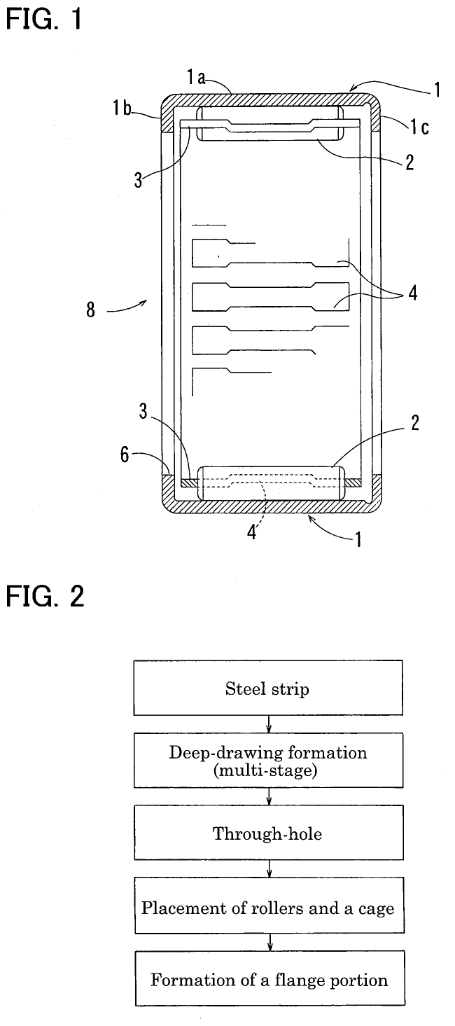

The first invention is directed to a shell-type needle roller bearing 8 characterized by a shell-type outer ring. FIG. 1 is a schematic sectional view illustrating an embodiment as one example of the shell-type needle roller bearing according to the first invention. The shown embodiment is one example, and the first invention is not limited to the shown embodiment. The shell-type outer ring 1 has a radially outer surface 1a having a substantially cylindrical shape, and having, on both axial sides thereof, ends 1b and 1c that are both bent radially inward. A plurality of needle rollers 2 are disposed radially inward of the shell-type outer ring 1 so as to come into contact with the shell-type outer ring 1. The needle rollers 2 are rotatably supported by a cage 3. The cage 3 has a substantially cylindrical shape having a diameter smaller than that of the shell-type outer ring 1, and has a plurality of window holes 4 facing the axial direction in accordance with the shapes of the needle rollers 2, and circumferentially equidistantly spaced apart from each other. The needle rollers 2 are received in the respective window holes 4, and rotate while maintaining equal intervals relative to each other. In the shell-type needle roller bearing 8, the needle rollers 2, which comprise many needle rollers, support a load between the shell-type outer ring 1 and the center axis of the baring.

The steps of manufacturing the shell-type needle roller bearing 8 are now described with reference to FIG. 2. A steel strip made of an austenitic stainless steel material is used as a material of the shell-type outer ring 1. The austenitic stainless steel material is a stainless steel having an austenite structure as its main structure at room temperature. The austenitic stainless steel material has chromium contributing to corrosion resistance, and nickel contributing to austenite structure. For example, SUS304 is exemplified as a representative austenitic stainless steel material, and can also be suitably used in the present invention. However, the shell-type outer ring 1 of the shell-type needle roller bearing according to the present invention is not limited thereto.

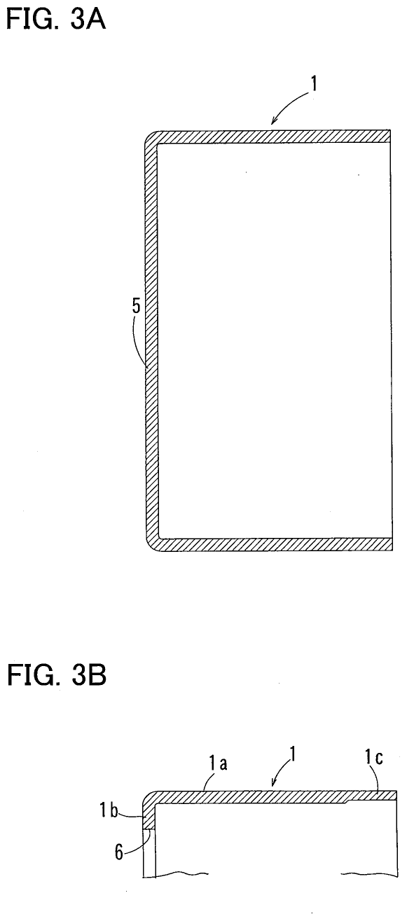

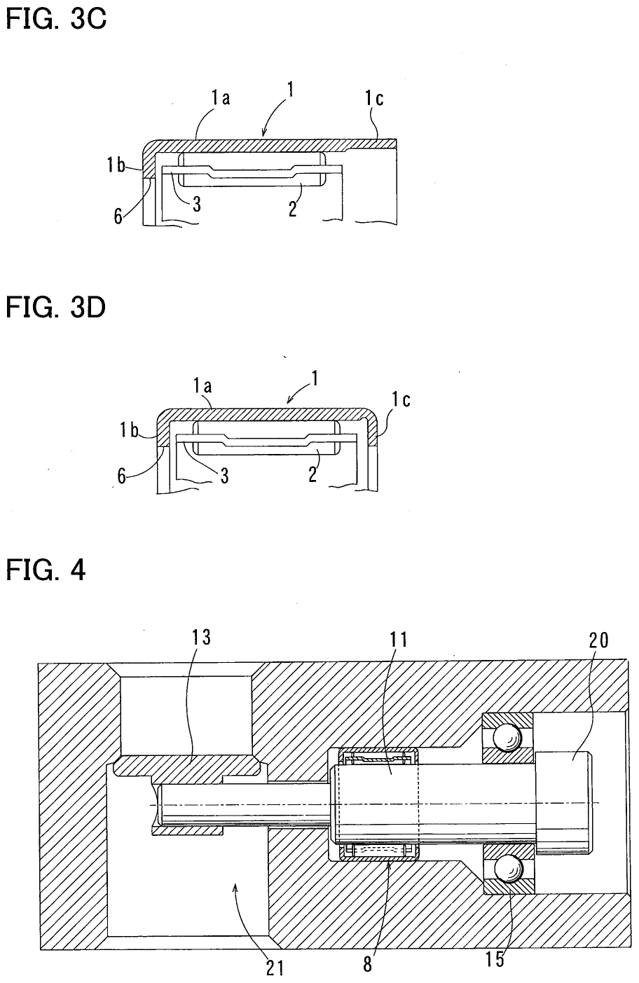

The steel strip is deformed into a cylindrical shape as illustrated in FIG. 3A by multi-stage deep drawing. The radially outer side of the shell-type outer ring 1 needs to have a smooth surface so as not to be caught and deformed when the bearing is press-fitted into a housing (described later). However, if the surface of the deep-drawn steel strip is too smooth, the steel strip will come into strong contact with the die, and thus seizure is likely to occur between the die and the steel strip. When manufacturing the shell-type outer ring 1 used in the first invention, by performing deep drawing in multiple stages, the shell-type outer ring 1 can be formed from a steel strip of an austenitic stainless steel material having a smooth surface. Due to deformation caused by the deep drawing at this time, the entire austenitic stainless steel material constituting the shell-type outer ring 1 has been hardened, and thus required hardness is ensured to some extent even if a heat treatment is not performed after assembly.

After forming the steel strip into a cylindrical shape by multi-stage deep drawing, a through-hole 6 is formed in the central portion of its bottom surface 5 so as to open the bottom surface 5. FIG. 3B is a partial sectional view illustrating the shell-type outer ring 1 in this state and the vicinity thereof. This is to manufacture an embodiment of an open-end type. However, the shell-type needle roller bearing 8 according to the first invention is not limited to such an open-end type of bearing, and may be a closed-end type of bearing. The end 1b (one of the two ends) on the side where a hole is formed is a portion bent inward from the radially outer surface 1a. The needle rollers 2 retained by the cage 3 are placed into the shell-type outer ring 1 so as to be caught by the bent end 1b. FIG. 3C is a partial sectional view illustrating the thus-placed state.

After placing the needle rollers 2 and the cage 3 into the shell-type outer ring 1, a flange portion is formed by bending the end 1c (the other of the two ends) of the shell-type outer ring 1 so as to prevent the needle rollers 2 and the cage 3 from moving out of the bearing, thereby completing the assembly. FIG. 3D is a partial sectional view illustrating a state in which the end 1c is bent. While the relevant figures illustrate an embodiment in which a single cage 3 is used, a plurality of cages 3 may be disposed in the axial direction.

Since, in the shell-type needle roller bearing 8 according to the first invention, the austenitic stainless steel material used for the shell-type outer ring 1 has been hardened, it is possible to achieve/ensure necessary hardness without performing a heat treatment after the above assembly is completed. Therefore, the radially outer surface of the shell-type needle roller bearing 8 includes a non-heat-treated surface, which is not subjected to a heat treatment.

The difference between the above non-heat-treated surface and a heat-treated surface, which is a surface subjected to a heat treatment, can be determined by checking the hardness gradient from the surface toward the interior. Strictly speaking, the non-heat-treated surface has also been hardened due to the influence of work hardening, but when actually making such a determination, depending on whether or not hardening exceeding the influence of work hardening is observed, it is possible to determine whether the surface is a heat-treated surface or a non-heat-treated surface. Also, since, if a nitriding treatment or the like is performed as a heat treatment, the metal structure is transformed, it is possible to make a more accurate determination by checking whether or not there is a compound layer or a diffusion layer.

The entire radially outer surface of the shell-type needle roller bearing 8 according to the first invention is basically a non-heat-treated surface. However, in some cases, a treatment for, e.g., softening or hardening the outer ring flange portion may be required due to functional reasons, and a part of the radially outer surface may be subjected to a heat treatment. However, even if such a heat treatment is partially performed, at least the axial position of the portion of the radially outer surface functioning as a raceway surface of the outer ring on which the rollers roll needs to be the above non-heat-treated surface. This is because if the area of the radially outer surface of the outer ring that is partially softened or hardened is wider/larger than the above-described area, a problem could occur when press-fitting the outer ring. The axial position of the portion of the radially outer surface functioning as the raceway surface of the outer ring, on which the rollers roll, can be identified by axially measuring the shape of the raceway surface of the outer ring, and checking a flat portion of the surface.

The radially outer surface 1a of the shell-type needle roller bearing 8 according to the first invention is desirably optimized in roughness within an allowable range for manufacturing. Especially it is preferable in terms of manufacturing cost to ensure a required small roughness (smoothness) without performing not only a heat treatment but also surface machining after deep-drawing the steel strip used for manufacturing. Due to such smoothness, it is possible to prevent deformation of the shell-type outer ring 1 due to an excessive press-fitting load when the shell-type needle roller bearing 8 is press-fitted into a housing having the accurate dimensions. On the other hand, the radially outer surface 1a having too small a roughness also has a problem, because if the original steel strip before being deep-drawn has too smooth a surface, seizure could occur when performing the above deep drawing,

Specifically, the radially outer surface 1a preferably has a roughness of the following values: The radially outer surface 1a preferably has an axial arithmetic average height Ra of 0.04 μm or more, because if the arithmetic average height Ra is less than 0.04 μm, this will significantly increase the likelihood of seizure during formation. On the other hand, the axial arithmetic average height Ra is preferably 0.13 μm or less, because if the arithmetic average height Ra is more than 0.13 μm, it is impossible to ignore the likelihood that the bearing may be caught when press-fitting the bearing into the housing.

Also, the axial maximum height Rz of the radially outer surface 1a is preferably 0.10 μm or more, because if the maximum height Rz is less than 0.10 μm, this will significantly increase the likelihood of seizure during formation. On the other hand, the axial maximum height Rz is preferably 1.70 μm or less, because if the axial maximum height Rz is more than 1.70 μm, it is impossible to ignore the likelihood that the bearing may be caught when press-fitting the bearing into the housing.

Also, the axial maximum valley depth of the radially outer surface 1a is preferably 0.10 μm or more and 1.43 μm or less. The skewness Rsk of peaks and valleys in the axial direction is preferably −2.4 μm or more and −0.1 μm or less. The axial kurtosis Rku of radially outer surface 1a is preferably 3.0 μm or more and 14.0 μm or less.

Also, it is suitable to set the circumferential roughness of the radially outer surface 1a within the following range: The circumferential arithmetic average height Ra of the radially outer surface 1a is preferably 0.03 μm or more and 0.13 μm or less. The circumferential maximum height Rz of the radially outer surface 1a is preferably 0.10 μm or more and 2.48 μm or less. The circumferential maximum valley depth of the radially outer surface 1a is preferably 0.10 μm or more and 2.19 μm or less. The skewness Rsk of peaks and valleys in the circumferential direction is preferably −3.8 μm or more and −0.1 μm or less. The circumferential kurtosis Rku of the radially outer surface 1a is preferably 3.0 μm or more and 26.2 μm or less.

If the outer diameter dimension of the shell-type needle roller bearing 8 according to the first invention is φ 12 mm or more and φ 30 mm or less, such a bearing is easily manufactured, and is suitable for practical use.

Also, the thickness of the shell-type outer ring 1 is desirably 0.4 mm or more and 1.0 mm or less in terms of strength and ease of machining.

The hardness of the raceway surface of the shell-type outer ring 1 is preferably HV 300 or more, and more preferably HV 400 or more. If the hardness is too low, this will significantly shorten the life of the bearing. The surface hardness of a conventional outer ring made of iron is about HV 750, but if the bearing is used not for high-speed rotation but for supporting a valve that slides to open and close, since the rotation speed is low, and the radial load is small, such a hardness is not required. Examples of a valve supported by the shell-type needle roller bearing 8 according to the first invention include, e.g., a valve of an automotive electronic throttle body (ETB) and a valve of an exhaust gas recirculation device (EGR). Since the shell-type needle roller bearing according to the first invention is made of an austenitic stainless steel material having excellent corrosion resistance, the shell-type needle roller bearing can be suitably used even for a valve of an ETB or an EGR exposed to an automotive exhaust gas.

FIG. 4 illustrates an example in which a valve of an EGR is supported by the shell-type needle roller bearing 8. A housing 20 is provided with an exhaust gas flow path 21, and a valve 13 is disposed in the exhaust gas flow path 21. The exhaust gas flow path 21 is opened and closed in accordance with rotation of the valve 13. The valve 13 is fixedly coupled to a rotary shaft 11. The shell-type needle roller bearing 8 together with a ball bearing 15 supports the rotary shaft. The shell-type needle roller bearing 8 according to the first invention is less likely to deform even when placed into the housing 20, and shows corrosion resistance even when exposed to the exhaust gas flowing in from the exhaust gas flow path 21.

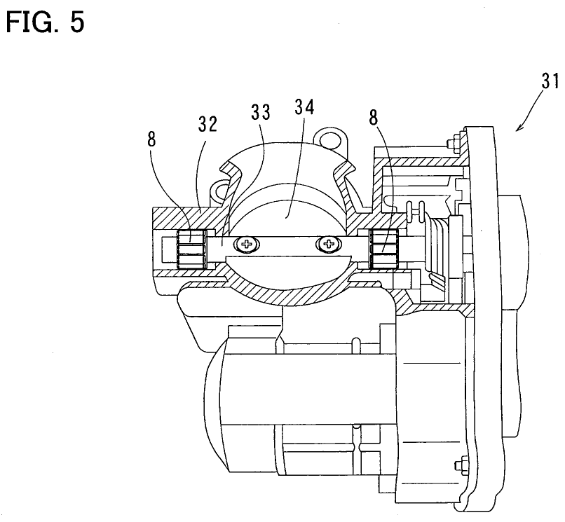

Also, FIG. 5 illustrates an example in which a valve of an ETB is supported by shell-type needle roller bearings 8 of the first invention. The shown throttle valve device 31 includes a throttle body 32 in which an intake passage is formed. Two shell-type needle roller bearings 8 of the first invention are press-fitted in a housing constituting the throttle body 32. The shell-type needle roller bearings 8 support a shaft 33, and support rotation of a valve 34 fixed to the shaft. Even when the shell-type needle roller bearings 8 come into contact with exhaust gas components introduced into the intake passage, the shell-type needle roller bearings 8 show corrosion resistance.

As the housing for supporting the shell-type needle roller bearing or bearings 8 for supporting such a valve, a housing made of aluminum is often used. The shell-type needle roller bearing or bearings 8 according to the first invention are hardened using an austenitic stainless steel material, and have sufficient hardness. Therefore, if the radially outer surface or surfaces have the above-mentioned roughness (smoothness), the shell-type needle roller bearing or bearings 8 are less likely to deform even when being press-fitted into the aluminum housing, and thus can be suitably used.

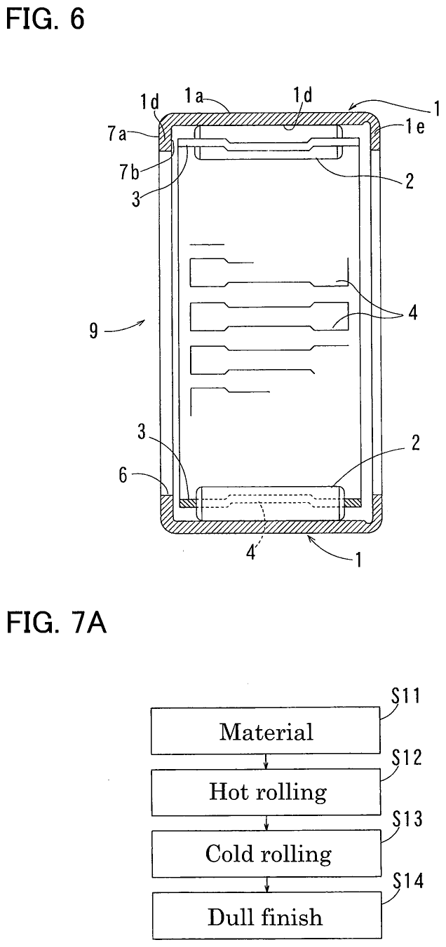

The second invention is directed to a shell-type needle roller bearing 9 characterized by a shell-type outer ring 1. FIG. 6 is a schematic sectional view illustrating an embodiment as one example of the shell-type needle roller bearing according to the second invention. The shown embodiment is one example, and the second invention is not limited to the shown embodiment. The shell-type outer ring 1 has a radially outer surface 1a having a substantially cylindrical shape. The ends of the radially outer surface on both axial sides thereof are both bent radially inward to form width surfaces 1d and 1e.

A plurality of needle rollers 2 are disposed radially inward of the shell-type outer ring 1 of the shell-type needle roller bearing 9 according to the second invention so as to come into contact with the shell-type outer ring 1. The needle rollers 2 are rotatably supported by a cage 3. The cage 3 has a substantially cylindrical shape having a diameter smaller than that of the shell-type outer ring 1, and has a plurality of window holes 4 facing the axial direction in accordance with the shapes of the needle rollers 2, and circumferentially equidistantly spaced apart from each other. The needle rollers 2 are received in respective the window holes 4, and rotate while maintaining equal intervals relative to each other. In the shell-type needle roller bearing 9, the needle rollers 2, which comprise many needle rollers, support a load between the shell-type outer ring 1 and the center axis of the bearing.

In the shell-type needle roller bearing 9 according to the second invention, the roughness of at least one of the width surfaces 1d and 1e of the shell-type outer ring 1 is greater/larger on a radially outer side surface than on a radially inner side surface. In this embodiment, the at least one of the width surfaces 1d and 1e is exemplified as the width surface 1d, which is constituted by a cylindrical bottom in a manufacturing step (described later). The above radially outer side surface (to which the reference number “7a” is applied) refers to the surface of the width surface 1d located on the axially outer side thereof, and the above radially inner side surface (to which the reference number “7b” is applied) refers to the surface of the width surface 1d located on the axially inner side thereof. Not only the width surface 1d but also the width surface 1e may satisfy the same condition for roughness.

The roughness is now described. In the shell-type needle roller bearing 9 according to the second invention, the arithmetic average roughness Ra of the radially outer side surface 7a of the width surface 1d of the shell-type outer ring 1 as the at least one of the width surfaces is desirably 0.2 μm or more and 1.5 μm or less. If the arithmetic average roughness Ra is less than 0.2 μm, it will be impossible to ensure sufficient oil reservoirs in the surface during deep-drawing formation, and thus to ensure sufficient lubricity, so that seizure is likely to occur. On the other hand, if the arithmetic average roughness Ra is more than 1.5 μm, unevenness will be too large, so that it will be difficult to perform deep-drawing formation. However, even if the radially outer side surface 7a is rough, there is no particular disadvantage with respect to the bearing after manufactured. On the other hand, the arithmetic average roughness Ra of the radially inner side surface 7b on the back side of the width surface 1d needs to be smaller than the arithmetic average roughness Ra of the radially outer side surface 7a, and is preferably 0.3 μm or less.

In the shell-type needle roller bearing 9 according to the second invention, the maximum height Rz of the radially outer side surface 7a of the width surface 1d of the shell-type outer ring 1 as the at least one of the width surfaces is preferably 1.5 μm or more and 10.3 μm or less. On the other hand, the maximum height Rz of the corresponding radially inner side surface 7b needs to be smaller than the maximum height Rz of the radially outer side surface 7a, and is preferably 2.0 μm or less.

In the shell-type needle roller bearing 9 according to the second invention, the maximum valley depth Rv of the radially outer side surface 7a of the width surface 1d of the shell-type outer ring 1 as the at least one of the width surfaces is preferably 1.0 μm or more and 4.0 μm or less. On the other hand, the maximum valley depth Rv of the corresponding radially inner side surface 7b needs to be smaller than the maximum valley depth Rv of the radially outer side surface 7a, and is preferably 1.0 μm or less. In the shell-type needle roller bearing 9 according to the second invention, the skewness Rsk of peaks and valleys of the radially outer side surface 7a of the width surface 1d of the shell-type outer ring 1 as the at least one of the width surfaces is preferably −1.9 μm or more and 1.6 μm or less. On the other hand, the skewness Rsk of peaks and valleys of the corresponding radially inner side surface 7b is preferably −0.5 μm or more and 0.8 μm or less.

In the shell-type needle roller bearing 9 according to the second invention, the kurtosis Rku of the radially outer side surface 7a of the width surface 1d of the shell-type outer ring 1 as the at least one of the width surfaces is preferably 1.2 μm or more and 4.6 μm or less. On the other hand, the kurtosis Rku of the corresponding radially inner side surface 7b is preferably 2.2 μm or more and 5.4 μm or less.

In the shell-type needle roller bearing 9 according to the second invention, the roughness of the surface of the shell-type outer ring 1 on the radially inner side thereof that comes into contact with the needle rollers is close to the roughness of the radially inner side surface 7b, unless the radially inner side is additionally machined after the end is formed. Therefore, if the radially inner side surface 7b is too rough, the outer ring is likely to hinder rolling of the needle rollers, and thus a smaller roughness is preferred.

The shell-type outer ring 1 of the shell-type needle roller bearing 9 according to the second invention is made of an austenitic stainless steel material. The austenitic stainless steel material is a stainless steel having an austenite structure as its main structure at room temperature. The austenitic stainless steel material has chromium contributing to corrosion resistance, and nickel contributing to austenite structure. For example, SUS304 is exemplified as a representative austenitic stainless steel material, and can also be suitably used in the present invention.

As the austenitic stainless steel material used for the shell-type outer ring 1 of the shell-type needle roller bearing 9 according to the second invention, it is possible to select, for example, a material containing 6.0 mass % or more and 17.0 mass % or less of Ni and 16.0 mass % or more and 26.0 mass % or less of Cr, and containing trace components and Fe as the balance. The trace components are, for example, 0.08 mass % or less of C, 1.0 mass % or less of Si, 2.0 mass % or less of Mn, 0.045 mass % or less of P, and 0.030 mass % or less of S. In addition to these, Mo, Cu and/or N may be added to such an extent that the effect of the shell-type needle roller bearing is not hindered.

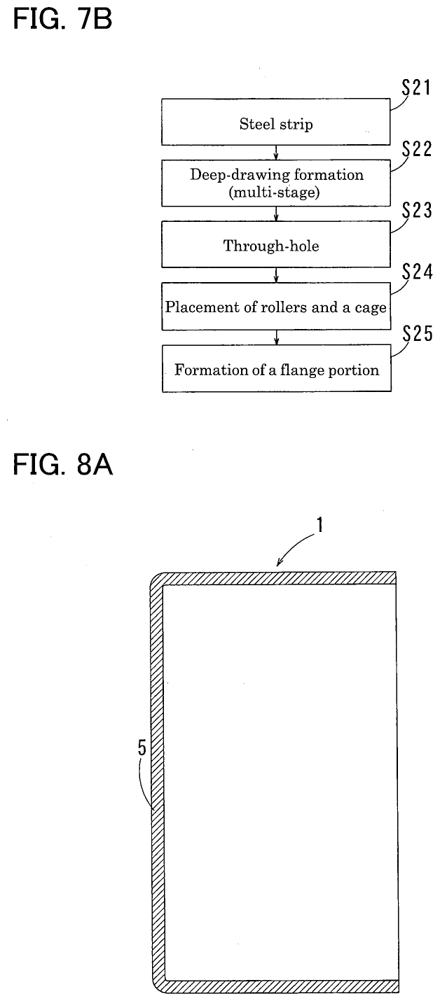

The steps of manufacturing the shell-type needle roller bearing 9 are now described with reference to FIGS. 7A and 7B. First, an austenitic stainless steel material is prepared that has been prepared in a predetermined component ratio (step S11). Examples of the components of the material include a stainless steel containing Cr and Ni mentioned in the above example. The hardness of the prepared material at its material stage is preferably 200 HV or less. The prepared material is first subjected to hot rolling so as to be rough-rolled into a sheet shape while maintaining the structure of the austenitic stainless steel material (step S12). The sheet-shaped material is cooled, and is then further subjected to cold rolling so as to be a steel strip having a smooth surface (step S13). At least one surface of the steel strip is subjected to a dull finish to roughen the surface (step S14). The one surface is to be the radially outer side surface 7a by deep-drawing (described later).

The arithmetic average roughness Ra of the above one surface at this stage after the dull finish is preferably 1.1 μm or more and 3.6 μm or less. The maximum height Rz thereof is preferably 6.0 μm or more and 14.8 μm or less. The maximum valley depth Rv thereof is preferably 3.1 μm or more and 8.1 μm or less. The skewness Rsk of peaks and valleys is preferably −1.4 μm or more and 0.9 μm or less. The kurtosis Rku thereof is preferably 1.5 μm or more and 2.7 μm or less. Since the surface to be the radially outer side surface is roughened as described above, it is possible to sufficiently ensure oil reservoirs in the surface during deep-drawing formation, and thus to ensure lubricity, so that seizure is less likely to occur. Since, if the surface to be the radially outer side surface is too rough, unevenness is too large, it is difficult to perform deep-drawing. Therefore, it is preferable not to make the surface too rough in any case

On the other hand, the other surface to be the radially inner side surface is not dull-finished, and has a level of roughness that cold-rolled steels normally have. For example, the arithmetic average roughness Ra thereof is preferably 0.04 μm or more and 0.10 μm or less, and the maximum height Rz thereof is preferably 1.50 μm or less. If such a degree of smoothness is ensured, the raceway surface 1d after the steel strip is machined into the shell-type outer ring 1 is usable as a bearing raceway surface.

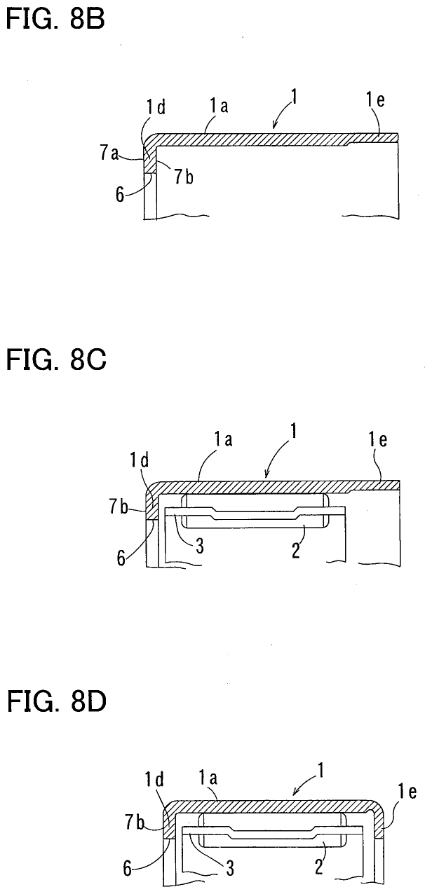

The steel strip in which the roughness of the one surface is different from the roughness of the other surface as described above (step S21) is deformed, by multi-stage deep drawing, into a cylindrical shape as illustrated in FIG. 8A (step S22). In order to ensure the accuracy required for a bearing, it is preferable to perform deep drawing in multiple stages consisting of not less than five stages. The step of reducing the plate thickness of the outer ring and eventually ensuring the bearing accuracy during deep-drawing formation, which is called “ironing”, is generally performed approximately one to three times in bearing machining. However, since the radially outer side of the outer ring and the radially inner side of the die are strongly rubbed against each other during ironing, the radially outer surface 1a of the outer ring 1 is reduced in roughness and becomes smooth, so that a sufficient oil film is not formed during machining, and a problem is likely to occur in machining. This phenomenon is noticeable in an austenitic stainless steel material, in which contact surface pressure tends to locally increase with work hardening. Therefore, it is preferable to reduce the number of times ironing is performed. By performing deep-drawing in a stepwise manner as described above, it is possible to machine an austenitic stainless steel material, which is a difficult-to-machine material. At this time, it is preferable in ensuring the bearing accuracy to machine the material such that the plate thickness of the outer ring raceway surface of a final product is 0.6 t mm or more and 0.9 t mm or less with respect to the material plate thickness t mm of the outer ring.

After forming the steel strip into a cylindrical shape by multi-stage deep drawing, a through-hole 6 is formed in the central portion of its bottom surface 5 so as to open the bottom surface 5 (step S23). FIG. 8B is a partial sectional view illustrating the shell-type outer ring 1 in this state and the vicinity thereof. This is to manufacture an embodiment of an open-end type. However, the shell-type needle roller bearing 9 according to the second invention is not limited to such an open-end type of bearing, and may be a closed-end type of bearing. The end (one of the two ends) on the side where a hole is formed includes the width surface 1d, which is a portion bent inward from the radially outer surface 1a. With respect to the shell-type needle roller bearing 9 according to the second invention, in the width surface 1d of the outer ring, which is this bent portion, the radially outer side surface 7a needs to be rougher than the radially inner side surface 7b, and preferably has the roughness satisfying the above conditions.

The needle rollers 2 retained by the cage 3 are placed into the shell-type outer ring 1 so as to be caught by the width surface 1d, which is constituted by the bent end (step S24). FIG. 8C is a partial sectional view illustrating the thus-placed state. After placing the needle rollers 2 and the cage 3 into the shell-type outer ring 1, a flange portion is formed by bending the other end of the shell-type outer ring 1 so as to prevent the needle rollers 2 and the cage 3 from moving out of the bearing, thereby completing the assembly (step S25). FIG. 8D is a partial sectional view illustrating a state in which the other width surface 1e is formed by bending this end. While the relevant figures illustrate an embodiment in which a single cag 3 is used, a plurality of cages 3 may be disposed in the axial direction.

Since, in the shell-type needle roller bearing 9 according to the second invention, the austenitic stainless steel material used for the shell-type outer ring 1 has been hardened, it is possible to achieve/ensure necessary hardness without performing a heat treatment after completion of the above assembly. However, a heat treatment may be performed as necessary. Also, surface finishing may be performed, e.g., in order to remove burrs generated during deep drawing of the outer ring or during formation of a through-hole.

The thickness of the shell-type outer ring 1 is desirably 0.4 mm or more and 1.0 mm or less in terms of strength and ease of machining.

Also, the shell-type needle roller bearing 9 according to the second invention may include a seal or seals in addition to the above components, and grease may be sealed therein.

The hardness of the raceway surface 1d of the shell-type outer ring 1 is preferably HV 300 or more, and more preferably HV 400 or more. If the hardness is too low, this will significantly shorten life of the bearing. The surface hardness of a conventional outer ring made of iron is about HV 750, but if the bearing is used not for high-speed rotation but for supporting a valve that slides to open and close, since the rotation speed is low, and the radial load is small, such a hardness is not required. Examples of a valve supported by the shell-type needle roller bearing 9 according to the second invention include, e.g., a valve of an automotive electronic throttle body (ETB) and a valve of an exhaust gas recirculation device (EGR). Since the shell-type needle roller bearing according to the second invention is made of an austenitic stainless steel material having excellent corrosion resistance, the shell-type needle roller bearing can be suitably used even for a valve of an ETB or an EGR exposed to an automotive exhaust gas.

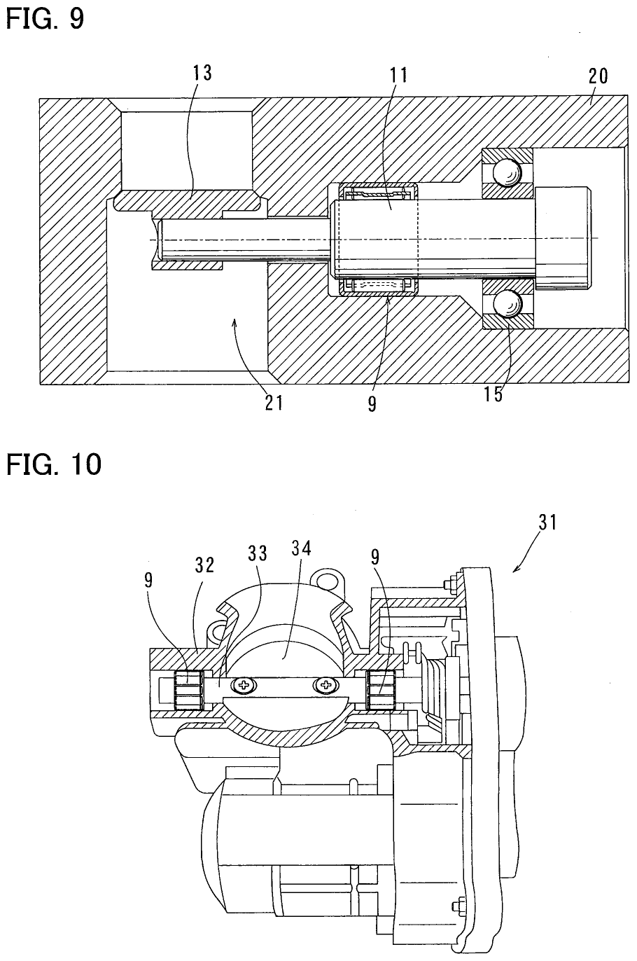

FIG. 9 illustrates an example in which a valve of an EGR is supported by the shell-type needle roller bearing 9. A housing 20 is provided with an exhaust gas flow path 21, and a valve 13 is disposed in the exhaust gas flow path 21. The exhaust gas flow path 21 is opened and closed in accordance with rotation of the valve 13. The valve 13 is fixedly coupled to the rotary shaft 11. The shell-type needle roller bearing 9 together with a ball bearing 15 supports the rotary shaft. The shell-type needle roller bearing 9 according to the second invention is less likely to deform even when placed into the housing 20, and shows corrosion resistance even when exposed to the exhaust gas flowing in from the exhaust gas flow path 21.

Also, FIG. 10 illustrates an example in which a valve of an ETB is supported by shell-type needle roller bearings 9 of the second invention. The shown throttle valve device 31 includes a throttle body 32 in which an intake passage is formed. Two shell-type needle roller bearings 9 of the second invention are press-fitted in a housing constituting the throttle body 32. The shell-type needle roller bearings 9 support a shaft 33 and support rotation of a valve 34 fixed to the shaft. Even when the shell-type needle roller bearings 9 come into contact with exhaust gas components introduced into the intake passage, the shell-type needle roller bearings 9 show corrosion resistance.

### EXAMPLE(S)

As a specific example of the shell-type needle roller bearing according to the first invention, shell-type outer rings were manufactured by multi-stage deep drawing, using a steel strip of SUS304, which is made of an austenitic stainless steel material. With respect to each of the shell-type outer rings, the outer diameter was 14 mm, the width was 14 mm, the roller inscribed circle diameter was 10 mm, and the thickness of the raceway surface was 0.5 m. The (plural) shell-type outer rings manufactured all have a raceway surface hardness Hv of 400 or more and 500 or less.

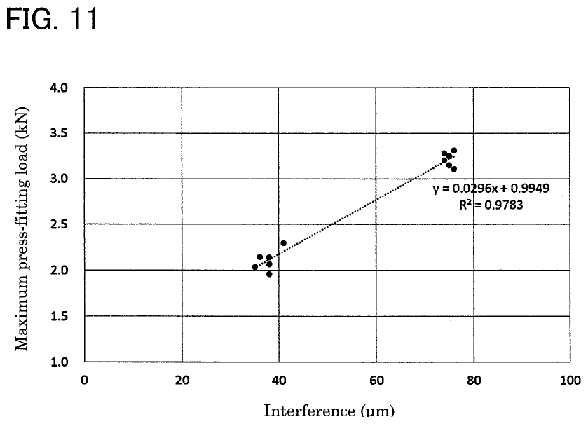

Aluminum housings were used, and press-fitting was performed in a range of interference of 35 μm to 76 μm assumed. FIG. 11 illustrates the maximum press-fitting load with respect to the interference. While the calculated value of the press-fitting load assumed from the above size of the outer ring was 3.1 kN, the measured value was about 3.3 kN. Therefore, it was confirmed that the placement can be performed without producing an excessive press-fitting load that may cause, for example, seizure.

### DESCRIPTION OF REFERENCE NUMERALS

1: shell-type outer ring
1a: radially outer surface
1b, 1c: end
1d, 1e: width surface
2: needle roller
3: cage
4: window hole
5: bottom surface
6: through-hole
7a: radially outer side surface
7b: radially inner side surface
8, 9: shell-type needle roller bearing
11: rotary shaft
13: valve
15: ball bearing
20: housing
21: exhaust gas flow path
31: throttle valve device
32: throttle body
33: shaft
34: valve

1. A shell-type needle roller bearing comprising a shell-type outer ring made of an austenitic stainless steel material,
wherein the shell-type outer ring has a radially outer surface including a non-heat-treated surface. Cm 2. The shell-type needle roller bearing according to claim 1, wherein the radially outer surface of the shell-type outer ring has a roughness set such that an arithmetic average roughness Ra in an axial direction is 0.04 μm or more and 0.13 μm or less, and such that a skewness Rsk of peaks and valleys in the axial direction is −2.4 μm or more and −0.1 μm or less.

3. The shell-type needle roller bearing according to claim 2, wherein the shell-type needle roller bearing has an outer diameter dimension of 012 mm or more and φ 30 mm or less.

4. The shell-type needle roller bearing according to claim 1, wherein the shell-type needle roller bearing is used while being press-fitted in a housing made of aluminum.

5. The shell-type needle roller bearing according to claim 1, wherein the shell-type needle roller bearing is used in an automotive electronic throttle body or an exhaust gas recirculation device.

6. The shell-type needle roller bearing according to claim 1,
wherein a radially outer side surface of at least one of axial width surfaces of the shell-type outer ring is rougher than a radially inner side surface of the at least one of the axial width surfaces.

7. The shell-type needle roller bearing according to claim 6, wherein the radially outer side surface of the at least one of the axial width surfaces has an arithmetic average roughness Ra of 0.2 μm or more and 1.5 μm or less.

8. The shell-type needle roller bearing according to claim 6, wherein the shell-type needle roller bearing is used in an automotive electronic throttle body or an exhaust gas recirculation device.

9. The shell-type needle roller bearing according to claim 2, wherein the shell-type needle roller bearing has an outer diameter dimension of φ 12 mm or more and φ 30 mm or less.

10. The shell-type needle roller bearing according to claim 2, wherein the shell-type needle roller bearing is used while being press-fitted in a housing made of aluminum.

11. The shell-type needle roller bearing according to claim 3, wherein the shell-type needle roller bearing is used while being press-fitted in a housing made of aluminum.

12. The shell-type needle roller bearing according to claim 9, wherein the shell-type needle roller bearing is used while being press-fitted in a housing made of aluminum.

13. The shell-type needle roller bearing according to claim 2, wherein the shell-type needle roller bearing is used in an automotive electronic throttle body or an exhaust gas recirculation device.

14. The shell-type needle roller bearing according to claim 3, wherein the shell-type needle roller bearing is used in an automotive electronic throttle body or an exhaust gas recirculation device.

15. The shell-type needle roller bearing according to claim 4, wherein the shell-type needle roller bearing is used in an automotive electronic throttle body or an exhaust gas recirculation device.

16. The shell-type needle roller bearing according to claim 9, wherein the shell-type needle roller bearing is used in an automotive electronic throttle body or an exhaust gas recirculation device.

17. The shell-type needle roller bearing according to claim 10, wherein the shell-type needle roller bearing is used in an automotive electronic throttle body or an exhaust gas recirculation device.

18. The shell-type needle roller bearing according to claim 11, wherein the shell-type needle roller bearing is used in an automotive electronic throttle body or an exhaust gas recirculation device.

19. The shell-type needle roller bearing according to claim 12, wherein the shell-type needle roller bearing is used in an automotive electronic throttle body or an exhaust gas recirculation device.

20. The shell-type needle roller bearing according to claim 7, wherein the shell-type needle roller bearing is used in an automotive electronic throttle body or an exhaust gas recirculation device.
